(19) United States
(12) Patent Application Publication
(10) Pub. No.: US 2014/0133042 A1
(43) Pub. Date: May 15, 2014

(54) WRISTBAND MIRROR

(71) Applicant: CyFy Cycle Products LLC, Greenwood Village, CO (US)

(72) Inventor: Rex Bird, Santa Barbara, CA (US)

(73) Assignee: CyFy Cycle Products LLC, Greenwood Village, CO (US)

(21) Appl. No.: 14/072,534

(22) Filed: Nov. 5, 2013

Related U.S. Application Data
(60) Provisional application No. 61/796,933, filed on Nov. 9, 2012.

(51) Int. Cl. G02B 7/00

(52) U.S. Cl. CPC G02B 7/002
USPC 359/871

(57) ABSTRACT

The present invention includes a convex mirrored surface encased in a housing, which is further attached to a slap band strap. The slap band strap is highly reflective. The mirrored can also display other information, lights or alarms, etc. All surfaces are capable of displaying emergency information, logos, messages, or advertising.

### RELATED APPLICATION INFORMATION

The present application claims priority under 35 U.S.C. §119 to U.S. Provisional Application No. 61/796,933, filed Nov. 9, 2012.

### FIELD OF THE INVENTION

This disclosure relates to personal safety and informational devices and, more particularly, to a highly reflective wrist band having a convex mirror surface.

### BACKGROUND OF THE DISCLOSURE

There is no safe and effective device a person can use when running, walking, jogging, cycling, skiing, snowmobiling, boating or working in professions and activities where safety is enhanced by improved peripheral vision. For instance, mirrors for use while bicycling are typically either mounted on the handlebar, which creates a safety issue in a crash, or on the bicyclist's helmet. In the latter instance, the wearer must swivel his or her head to see different rearview angles, which creates safety issues.

There is a need for an improved means for enhancing peripheral vision while active without introducing cumbersome accoutrements.

### SUMMARY OF THE INVENTION

The present application provides a wristband mirror with a convex mirrored surface encased in a housing attached to a slap band strap. The slap band strap is highly reflective. The wristband mirror can also display other information, lights or alarms, etc. All surfaces are capable of displaying logos, messages, or advertising.

The wristband mirror can easily, quickly and snuggly attach to arm, leg, or any place the wearer wants to obtain a view out of his field of vision or be seen due to the wristband mirror reflectivity or other attributes. The wristband mirror is an ideal safety device to be used in road construction, for railroad workers, or any job or activity where awareness of objects outside one's peripheral vision improves awareness and safety. The wristband mirror helps you see and to be seen.

The wristband mirror consists of a convex reflective mirror or highly reflective circle or other appropriate shaped surface, which can be worn on the wrist, arm, leg, and ankle or otherwise, attached to any desired appendage or object.

The slap band strap and or the surface can also accommodate a logo or a message. The back of the wristband mirror slap band is desirably covered with a non-abrasive, comfortable material. The slap band is attached to the reflective surface mound by brad, screw, or other appropriate means.

The wristband mirror is an ideal safety device to be used when running, walking, jogging, cycling, skiing, snowmobiling, boating or other water sports, or when working in professions and activities where safety is enhanced by improved peripheral vision.

### DESCRIPTION OF THE DRAWINGS

FIG. 1A shows a man riding a bicycle and wearing the wristband mirror of the present application;

FIG. 1B is an enlarged view of the wristband mirror mounted on the wearer's arm;

FIG. 2A is a front plan view of the exemplary wristband mirror laid out flat; and

FIG. 2B is a rear plan view of the exemplary wrist band mirror laid out flat.

### DETAILED DESCRIPTION

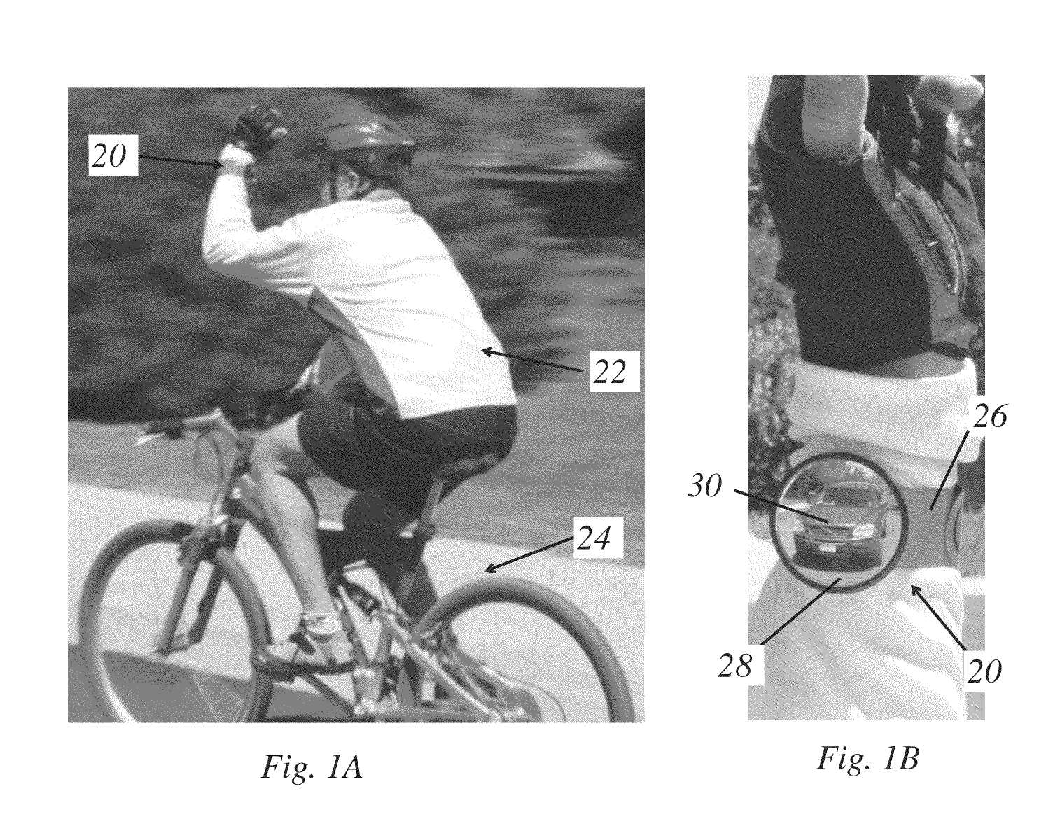

The present application provides a wristband mirror for use with all sorts of activities. An exemplary usage is shown in FIG. 1A in which the wristband mirror 20 is worn on the arm of a man 22 riding a bicycle 24. As seen in the enlargement of FIG. 1B, the wristband mirror 20 comprises a wristband or strap 26 on which the mirror 28 is mounted. The strap 26 typically has two free ends with mating fasteners, or may be formed as a continuous loop of elastic material. In a preferred embodiment, the mirror 28 is convex so as to provide a “fisheye” view, enhancing visibility over a wider range of view, such as indicated by the car 30 in FIG. 1B. A convex mirror permits the wearer to ascertain other persons, animals, or objects, behind or slightly beyond the normal peripheral vision field.

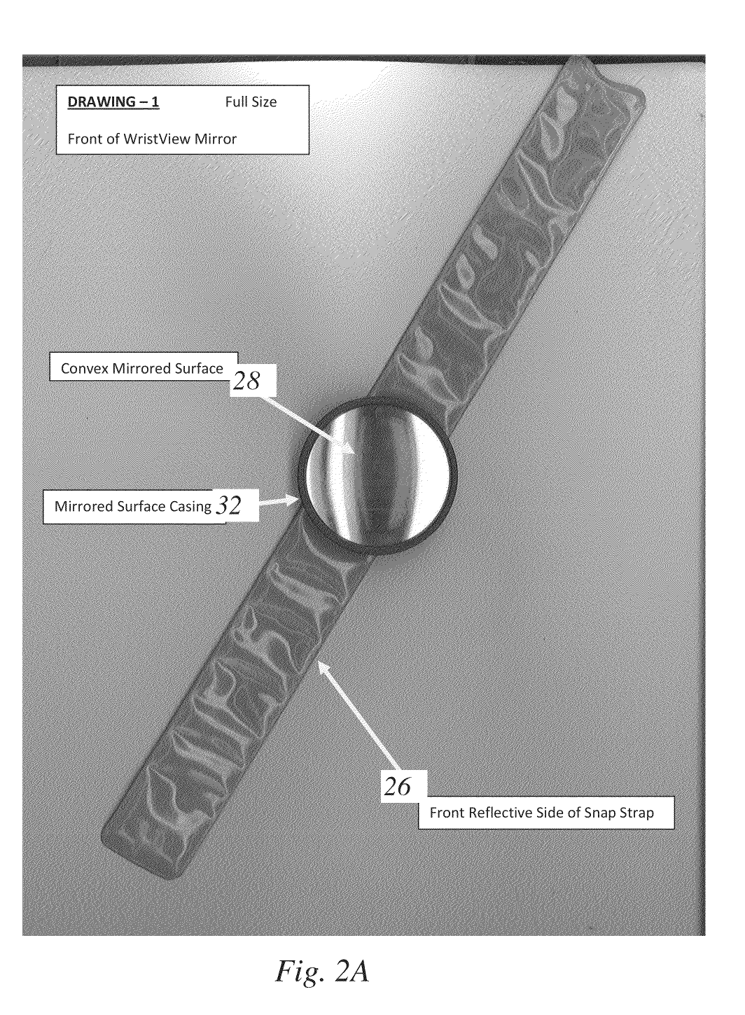

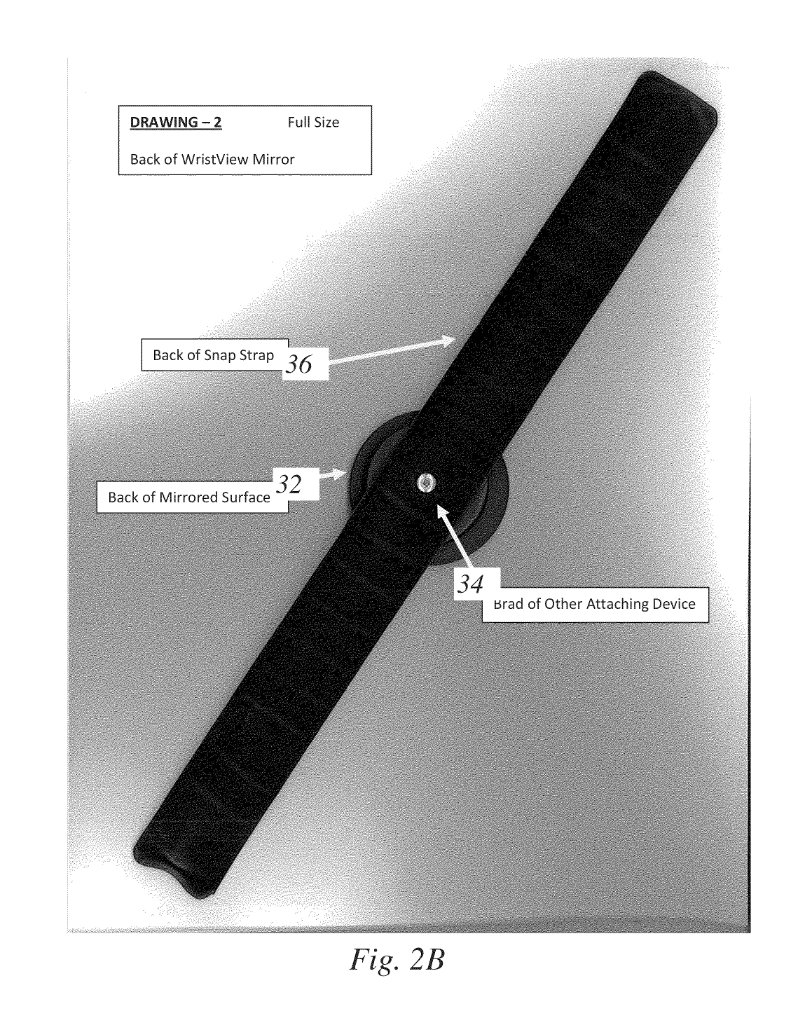

FIGS. 2A and 2B illustrate exemplary constructional details of the wristband mirror 20. In particular, the mirrored surface 26 is mounted within a casing 32, typically plastic, that mounts to the strap 26. For example, the casing 26 may be molded plastic having a stud that passes through an aperture in the material of the strap 26, and fastened by a brad 34 on the back side 36 of the strap. The back side 36 is preferably made of a non-abrasive, comfortable material. In a preferred embodiment, the mirrored surface 26 comprises a circular convex mirror having a diameter of between 1.5-3.0 inches.

A preferred embodiment of the mirror includes one circular surface with no implanted attributes. However, the mirror is not limited to this shape and can be constructed to allow pivoting rotating, angling or lifting of the mirror. This will allow the user increased visibility based on the positioning of the attachment.

In a preferred embodiment, the strap 26 is also highly reflective, enabling others to see the wearer of the wristband mirror 20. For example, the front or outer side of the strap 26 may be made of fluorescent (e.g., Day-Glo) green or orange, or the strap may have a highly glossy or reflective appearance, such as used with reflective safety clothing.

Another safety feature of the wristband mirror 20 comprises emergency contact information, drug allergy cautions, blood type, or the like (collectively, “emergency information”) printed thereon. Preferably, the material of the strap 26 is water-resistant and the emergency information is printed thereon with indelible ink. In addition, the strap 26 can display logos, messages, or advertising. In an alternative embodiment, the wristband mirror 20 may include a pocket (not shown) formed in the strap 26 for containing a water-resistant insert (to resist smearing) having the emergency information printed thereon.

For cyclists, the wristband mirror is a convex mirror mounted on a high reflective slap band with a goal of improving cycling safety. Before you initiate a left turn or merge, simply hold up your arm glance at the wristband mirror, and see if there are cars trailing you to the left.

With the exception of cumbersome and dangerous devices either put on helmets, handlebars, etc. wristband mirrors are safer than bicycle helmet mounted mirrors by providing a wider field of view and no vibration. Wristband mirrors are safer than handle bar mounted mirrors because you never have to adjust the mirror while road biking and you will never impulsively turn the wheel in the opposite direction to see what is behind you.

The wristband mirror attaches instantly and snuggly via a reflective slap band to arm, wrist, etc. It also does this without latches, Velcro etc. The convex surface is either totally reflective or not. It is large enough to have an appropriate amount of not reflective surface. The wristband mirror's depth will accommodate other devices to be applied between the reflective surface and where the back of the casing holding the reflective surfaces attaches to the snap band. A device implanted in the non-reflective portion of the wristband mirror can display information including but not limited to, time, elapsed time, altitude, direction etc. It might also have a light, alarm, etc.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of,” respectively, are closed or semi-closed transitional phrases with respect to claims. Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A wearable mirror, comprising:
a) a convex mirrored surface; and
b) a reflective strap to which the convex mirrored surface is mounted.

2. The mirror of claim 1, wherein the reflective strap is formed of a water-resistant material.

3. The mirror of claim 2, wherein the reflective strap has information printed thereon with indelible ink.

4. The mirror of claim 1, wherein the reflective strap has a fluorescent color.

5. The mirror of claim 1, wherein the reflective strap as a highly glossy appearance.

6. The mirror of claim 1, wherein the convex mirrored surface is circular and mounted within a housing fastened to the strap.

7. The mirror of claim 6, wherein the housing is constructed to allow pivoting rotating, angling or lifting of the convex mirrored surface.
